(19) United States
(12) Patent Application Publication
(10) Pub. No.: US 2024/0148604 A1
(43) Pub. Date: May 9, 2024

(54) SYSTEM AND METHOD FOR EROGENOUS STIMULATION

(71) Applicant: Paul Efron, Oro Valley, AZ (US)

(72) Inventor: Paul Efron, Oro Valley, AZ (US)

(21) Appl. No.: 18/125,061

(22) Filed: Mar. 22, 2023

Related U.S. Application Data
(60) Provisional application No. 63/382,508, filed on Nov. 5, 2022.

(51) Int. Cl. A61H 19/00

(52) U.S. Cl. CPC A61H 19/50; A61H 19/34; A61H 19/44; A61H 2201/0153; A61H 2201/1207; A61H 2201/1685

(57) ABSTRACT

A sex aid and method of use is provided with a handle and at least one stimulator to be applied to a user. Varied stimulators may be coupled to the handle using an oblong cutout and a stimulator having a body and an extension where a face is separated from the body by a stem. The length of the stem may correspond to the depth of the oblong cutout such that the face can be fit through the oblong cutout and rotated to secure the stimulator to the handle. When the sex aid is desired to be used by a plurality of users, a plurality of oblong cutout may be used to attach a plurality of stimulators. One stimulator may be used by one user on the user side of the handle and another stimulator may be used by a second user on the opposite side of the handle.

### CROSS REFERENCE TO RELATED APPLICATION

This application claims benefit from currently pending U.S. Provisional Application No. 63/382,508 titled “J-Toy” and having a filing date of Nov. 5, 2022, all of which is incorporated by reference herein.

### BACKGROUND OF THE INVENTION

### Field of the Invention

This invention relates generally to sex toys. More particularly, the present invention relates to a modular ergonomic sex toy.

### Description of Related Art

One of the great monuments to human ingenuity is the number and variety of physical aids for stimulating or eliciting a sexual response that have been developed over time. Sexual aids typically include at least one stimulator, that stimulates an erogenous zone of the body during use. A variety of stimulators have been used, including penetrating bodies that are intended to be at least partially inserted into the anal or vaginal canal of a user, and sensations drives. A sensations drive is any mechanism configured to provide a desired sensation to the user. Examples of sensation drives include vibrators, air or sonic pulses, flicking tongues, suction, clamps, electrical stimulators, and other elements known to those having skill in the art to provide a desired sensation to the user. Combinations have been developed that may include one element for stimulating the clitoris or penis and a penetrating body that allows dual stimulation of the penis and anus for male users and the clitoris, vagina, and/or anus for female users.

The clitoris is a highly sensitive sexual body part and is the only organ in the human body with the sole function of providing pleasure. It is composed of several parts, including the glans or head, the shaft which continues towards the pubic bone, and two legs or crura that are surrounded by erectile tissue known as the vestibular bulbs that partially surround the vaginal opening. When people refer to the clitoris, they are typically referring to the glans specifically. During orgasm, the clitoris becomes erect due to increased blood flow and engorgement, and the hood of the clitoris covers the glans.

Conventional sex aids have been effective in varying degrees, however, many of these aids require the involvement of a partner, whether male or female and can be awkward, requiring unnatural or uncomfortable positioning. Many women experience trouble reaching orgasm due to a failure to relax. Any feelings of awkwardness or discomfort can delay or diminish sexual fulfillment. The standard penis shaped dildo vibrator (PS) requires the user to have their hand too far away to fully extend their body during use. As such, there is still a long-standing need for a sex aid that can closely simulate sexual intercourse without the use of hand manipulation and can be used at any tempo, manner, or degree of gentleness or roughness desired by the user in a natural position.

To reduce the complexity and length of the Detailed Specification, and to fully establish the state of the art in certain areas of technology, Applicant(s) herein expressly incorporate(s) by reference all the following materials identified in each numbered paragraph below. The incorporated materials are not necessarily “prior art” and Applicant(s) expressly reserve(s) the right to swear behind any of the incorporated materials.
U.S. Pat. No. 5,725,473 to Taylor, issued Mar. 10, 1998, filed Aug. 28, 1995.
U.S. Pat. No. 6,179,795 to Garza, issued Jan. 30, 2001, filed Apr. 26, 1999.
U.S. Pat. No. 6,899,671 to Fontenot, issued May 31, 2005, filed Jan. 12, 2004.
U.S. Pat. No. 6,991,599 to Hudson, issued Jan. 31, 2006, filed Feb. 25, 2004.
U.S. Pat. No. 7,513,868 to Fontenot, issued Apr. 7, 2009, filed May 3, 2007.
U.S. Pat. No. 9,295,572 to Stout, issued Mar. 29, 2016, filed Mar. 11, 2011.
U.S. Pat. No. 9,730,857 to Loya, issued Aug. 15, 2017, filed Sep. 19, 2015.
U.S. Pub. No. US 2004/0186344 to Jannuzzi, published Sep. 23, 2004, filed Feb. 5, 2004.
U.S. Pub. No. US 2006/00417181 to Hsu, published Mar. 2, 2006, filed Sep. 1, 2004.
U.S. Pub. No. US 2008/0139980 to Fladl et al. published Jun. 12, 2008, filed Oct. 13, 2006.
U.S. Pub. No. US 2009/0247915 to Imboden et al., published Oct. 1, 2009, filed Mar. 30, 2009.
U.S. Pub. No. US 2010/0041944 to Levy, published Feb. 18, 2010, filed Aug. 11, 2009.
U.S. Pub. No. US 2011/0082332 to Lee, published Apr. 7, 2011, filed Oct. 6, 2009.
U.S. Pub. No. US 2014/0024980 to Ortiz, published Jan. 23, 2014, filed Jul. 20, 2012.

Applicant(s) believe(s) that the material incorporated above is “non-essential” in accordance with 37 CFR 1.57, because it is referred to for purposes of indicating the background of the invention or illustrating the state of the art. However, if the Examiner believes that any of the above-incorporated material constitutes “essential material” within the meaning of 37 CFR 1.57(c)(1)-(3), applicant(s) will amend the specification to expressly recite the essential material that is incorporated by reference as allowed by the applicable rules.

### BRIEF SUMMARY OF THE INVENTION

The present invention provides among other things a sex aid toy that provides modular variability and customizable ergonomics for applying known sex aid stimulation drives.

It is an object of the invention to provide a low-profile sex aid that can be used by a couple during intercourse.

It is another object of the invention to provide a sex aid with a penetrating body and a stimulation drive and a handle that allows the user to ergonomically apply motion or pressure to the sex toy.

It is another object of the invention to provide a sex toy handle that allows desirable amounts of pressure at a penetration site and at a pleasure zone site simultaneously.

It is another object of the invention to provide a sex aid that can be used by both users in a couple during sex.

It is another object of the invention to provide a sex aid that may be held at around breast height of the user.

It is another object of the invention to provide a handle battery that can provide power for a plurality of modular elements when the modular elements are electrically connected to the handle battery.

It is another object of the invention to provide an ergonomic handle and sex aid for use with two female users.

It is another object of the invention to provide a modular sex aid handle that allows access to elements on the sex aid handle to a plurality of users, with varying genitalia.

It is another object of the invention to provide a method of selecting modular elements for use in a sexual experience, coupling the modular elements to a desired point on a base handle, and using the modular elements to enhance the sexual experience.

It is another object of the invention to provide modular elements that may be electronically connected to, and controlled through a user interface on, the handle.

It is another object of the invention to provide a handle that can be coupled to a strap on to allow pressure to be relayed to a sex toy coupled to the strap on.

It is another object of the invention to provide a sex aid that is more usable for differently abled individuals.

It is another object of the invention to provide a sex aid that may be easily and efficiently manufactured and marketed.

It is another object of the invention to provide a handle compatible with a wide variety of existing modular sex aid products.

It is another object of the invention to provide a base handle that may be used with a wide variety of stimulators.

The above and other objects may be achieved using devices involving a sex toy accessory system or sex aid for facilitating sexual arousal of a user. The sex aid can have a handle with a grip on one end and a stimulation area on the other end. The length of the handle may be about 18 inches and may be curved such that the stimulation area is directed at an angle from the general line of the handle. The stimulation area includes at least one oblong cutout to couple at least one stimulator to the handle.

The stimulator is a penetrating body or a sensation drive and the stimulator may have a body and an extension where a face is separated from the main body of the simulator by a stem. The length of the stem may correspond to the depth of the oblong cutout such that the face can be shaped to fit through the oblong cutout and be rotated to secure the stimulator to the stimulation area. The handle or the stimulator may be configured to have a mechanical stop on that limits the rotation of the stimulator relative to the handle.

The sensation drive may be any combination of at least one of a vibrator, an air pulse, a tongue flicker, a clamp, suction, and electrical stimulation. The penetrating body may allow existing penetrating bodies to be coupled to the handle. In one embodiment, a sensation drive and a penetrating body are both provided, and the sensation drive is spaced to contact the user's clitoris or penis when the penetrating body is inserted into a user. The distance between the penetrating body and the sensation drive may be adjustable to allow every user to find the right spacing for them.

The sex toy accessory system may be used with a couple or a plurality of users. The stimulation area may include a plurality of oblong cutout to accommodate a plurality of stimulators. One oblong cutout is configured to accommodate a first stimulator such that the first stimulator may be used by a first user on one side of the handle, and a second oblong cutout is configured to accommodate a second stimulator to be used by another use on the opposite side of the handle. The user(s) may thus insert the stimulation area between the users and place themselves and the stimulators to maximum advantage.

The sex toy accessory system may also be used to provide a common power source to a variety of different sensation drives. The handle may include a battery power source and an electrical lead situated near the oblong cutout such that when the stimulator is rotated and coupled to the handle, the electrical lead from the handle is in electrical communication with a corresponding electrical lead on the body of the stimulator to provide an electrical connection between the handle and at least one stimulator.

The above and other objects may be achieved using methods involving providing a sex aid handle with a grip end on one side and a stimulation end opposite the grip end and stimulators that may be coupled to the sex aid handle. The handle comprises at least one oblong cutout near the stimulation and a stimulator is configured to have a body and an extension with a stem and a face. The face is designed to fit through the oblong cutout and then rotate to secure the stimulator to the handle. The handle and at least one stimulator can be provided to a user for assembly and/or use as a sexual aid.

The handle may also have a power source, and the method may include configuring the stimulator and the handle such that a user may couple an electrical lead on the handle to an electrical lead on the stimulator. A penetrating body may be coupled to or integral with the handle and oblong body spaced apart from the penetrating body to locate the stimulator near the penis or clitoris of the user when the penetrating body is completely inserted into the user.

For partnered use, the handle may have a user side configured to face the user during use, an opposing side opposite to the user side. The stimulation end has at least two oblong cutouts to couple two or more stimulators to the handle. A plurality of different kinds of penetrating bodies and/or sensation drives are provided as stimulators, each having a body and an extension from the body by a stem. The length of the stem may generally correspond to the depth of the oblong cutout such that the stimulator may be coupled to the handle from the user side of the handle and from the opposing side.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors' intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for,” and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

### BRIEF DESCRIPTION OF THE SEVERAL VIEWS OF THE DRAWINGS

A more complete understanding of the present invention may be derived by referring to the detailed description when considered in connection with the following illustrative figures. In the figures, like reference numbers refer to like elements or acts throughout the figures.

FIG. 1 depicts an upright right perspective view of a sex aid according to one or more embodiments.

FIG. 2 depicts an upright side view of a sex aid according to the embodiment of FIG. 1.

FIG. 3a depicts an overhead perspective view of a stimulator according to one or more embodiments.

FIG. 3b depicts an underside perspective view of a sex aid according to the embodiment of FIG. 3a.

FIG. 4 depicts an underside closeup view of the stimulation end of a sex aid according to one or more embodiments.

FIG. 5 depicts an upright left perspective view of a sex aid according to one or more embodiments.

FIG. 6 depicts skewed front view of a sex aid according to one or more embodiments.

FIG. 7 depicts a side view of a sex aid according to one or more embodiments.

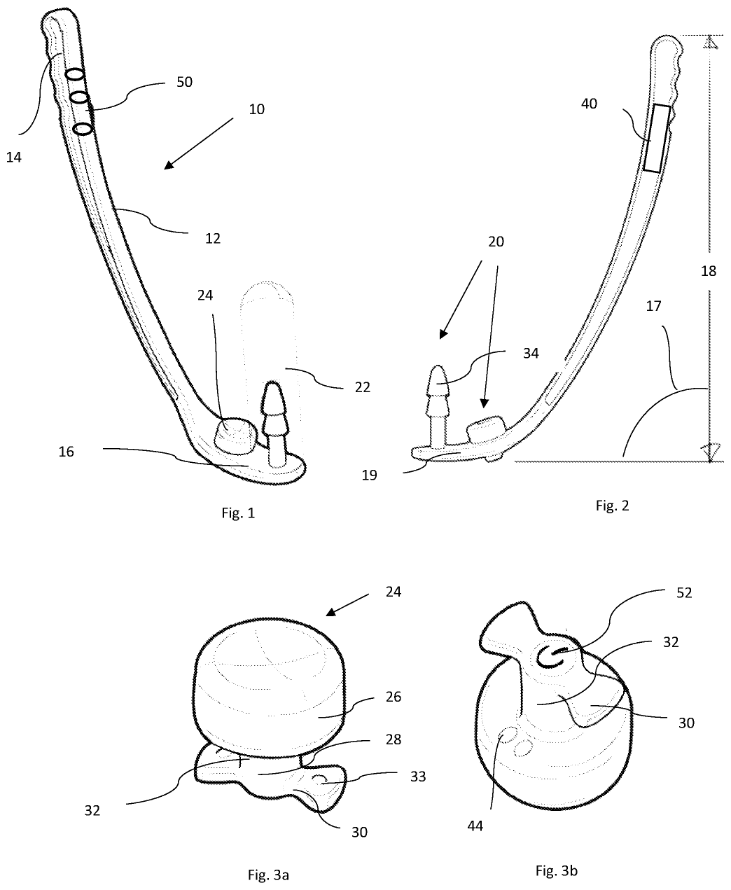

Elements and acts in the figures are illustrated for simplicity and have not necessarily been rendered according to any particular sequence or embodiment.

LISTING OF REFERENCE ELEMENTS IN THE DRAWINGS

| No. | Element |
|---|---|
| 10 | Sex Aid |
| 12 | Handle |
| 14 | Grip |
| 15 | Oblong cutout |
| 16 | Stimulation area |
| 17 | Angle |
| 18 | Length of the handle |
| 20 | Stimulator |
| 22 | Penetrating Body |
| 24 | Sensation Drive |
| 26 | Sensation drive body |
| 28 | Sensation drive extension |
| 30 | Sensation drive face |
| 32 | Sensation drive stem |
| 33 | Sensation drive mechanical stop |
| 34 | Barbed peg |
| 40 | Battery power source |
| 42 | Electrical lead |
| 50 | Control interface |
| 52 | Control interface |
| 100 | First stimulator |
| 102 | Second stimulator |
| 110 | User side |
| 120 | Opposing side |

### DETAILED DESCRIPTION OF THE INVENTION

In the following description, and for the purposes of explanation, numerous specific details are set forth to provide a thorough understanding of the various aspects of the invention. It will be understood, however, by those skilled in the relevant arts, that the present invention may be practiced without these specific details. In other instances, known structures and devices are shown or discussed more generally to avoid obscuring the invention. In many cases, a description of the operation is sufficient to enable one to implement the various forms of the invention, particularly when the operation is to be implemented in software. It should be noted that there are many different and alternative configurations, devices, and technologies to which the disclosed inventions may be applied. The full scope of the inventions is not limited to the examples that are described below.

In one application of the invention, a sex aid 10 is provided having a handle 12 a handle with a grip 14 on one end and a stimulation area 16 on the other end. The length of the handle 18 may be about eighteen inches and may be curved such that the stimulation area 16 is directed at an angle 17 from the general line of the handle 12. The handle 12 may be composed of plastic, silicon, or any other material known by those having skill in the art and may be curved without any marked angle changes or may be notably hinged to maximize ergonomics. The stimulation area 16 includes at least one oblong cutout 15 to couple at least one stimulator 20 to the handle 12.

The stimulator 20 is a penetrating body 22 or a sensation drive 24 and the stimulator 20 may have a body 26 and an extension 28 where a face 30 is separated from the main body 26 of the simulator 20 by a stem 32. The length of the stem may correspond to the depth of the oblong cutout such that the face 30 can be shaped to fit through the oblong cutout 15 and be rotated to secure the stimulator 20 to the stimulation area 16. The handle 12 or the stimulator 20 may be configured to have a mechanical stop 33 that limits the rotation of the stimulator 20 relative to the handle 12. The space created by stem 32 may also be configured to be about the size of a user's fingers, so the user may hold the device comfortably when using it independently as described below.

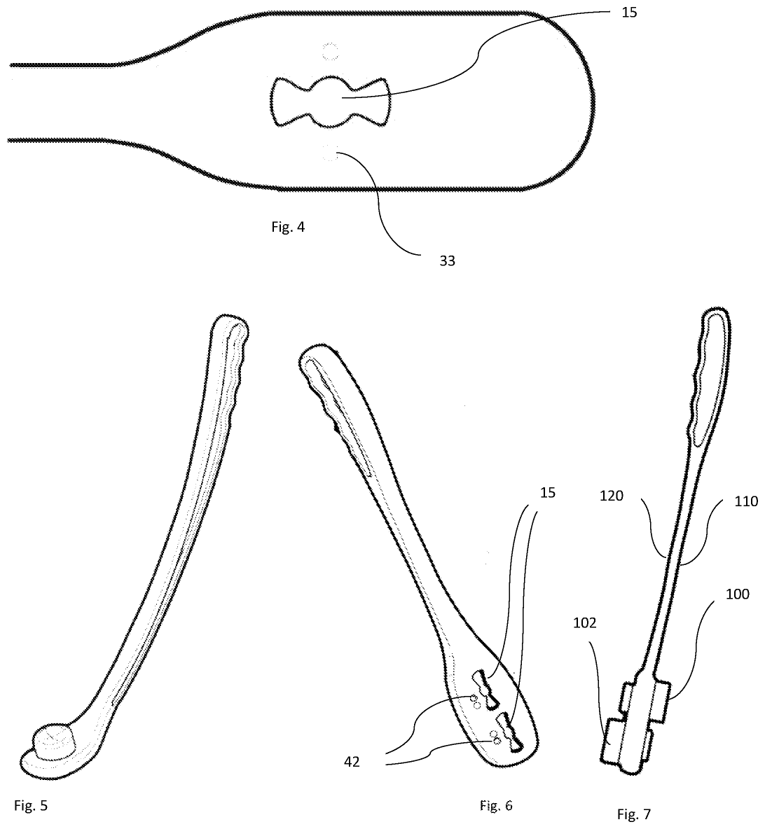

The sensation drive 24 may be any combination of at least one of a vibrator, an air pulse, a tongue flicker, a clamp, suction, and electrical stimulation. The penetrating body 22 may allow existing penetrating bodies to be coupled to the handle. A barbed peg 34 or a threaded cylinder may be used to allow existing dildoes to be used with the handle 12. In one embodiment, a sensation drive 24 and a penetrating body 22 are both provided and the sensation drive 24 is spaced to contact the user's clitoris or penis when the penetrating body 22 is fully inserted into the user. The distance between the penetrating body 22 and the sensation drive 24 may be adjustable to allow every user to find the right spacing for them. As particularly shown in FIG. 5, the low profile of the sex aid 10 allows the sex aid 10 to be used for sexual stimulation during copulation, most frequently done while a female partner is on top of a male partner laying on his back with either partner holding the device so the sensation drive 24 could touch the female's clitoris.

The sex toy accessory system may be used with a couple or a plurality of users. The stimulation area 16 may include a plurality of oblong cutouts 15 to accommodate a plurality of stimulators 20. One oblong cutout is configured to accommodate a first stimulator 100 such that the first stimulator 100 may be used by a first user on one side of the handle, and a second oblong cutout 15 is configured to accommodate a second stimulator 102 to be used by another use on the opposite side of the handle. The user(s) may thus insert the stimulation area between the users and place themselves and the stimulators to mutual advantage.

The sex toy accessory system may also be used to provide a common power source to a variety of different sensation drives. The handle 12 may include a battery power source 40 and an electrical lead 42 situated near the oblong cutout 15 such that when the stimulator 20 is rotated and coupled to the handle 12, the electrical lead 42 from the handle is in electrical communication with a corresponding electrical lead 44 on the body 26 of the stimulator 20 to provide an electrical connection between the handle 12 and at least one stimulator 20. The battery can be rechargeable or replaceable. In a particular embodiment, the battery is two size AA batteries.

In alternative embodiment, the electrical lead 44 on the body of the sensation drives 24 are 2 electrical contact points used to charge a rechargeable battery (not shown) within the body 26 of a stimulator 20. The electrical contact points may magnetically couple to a recharging cable such that the stimulator 20 can be used on their own as a vibrator. The independent stimulator 20 may be used as a convenient travel device.

The sex toy accessory system may include a control interface 50 near the grip end 14 of the handle 12. The control 50 may be electrically coupled to the battery power source 40 and can send instructions and power along the electrical lead 42 to any connected stimulators 20. In a particular embodiment shown in FIG. 3b, each stimulator 20 has its own independent control interface 52 and power source.

In use, a user selects a stimulator 20 or a plurality of stimulators 20 to use with the handle 12. The user may select a penetrating body 22, a sensation drive 24, or both. The stimulator(s) are coupled to the handle 12 either using the method of attaching an existing product (like barbed peg 34) or using the oblong cutouts 15, whereby the user inserts the face 30 through the oblong hole 15 and rotates the stimulator 20 to secure the stimulator 20 in place. The handle and at least one stimulator can be provided to a user for assembly and/or use as a sexual aid.

The user may use the power source 40 and/or the user interface 50 of the handle 12 in connection with the stimulators 20. A cable harness known to those having skill in the art may be used or the electrical leads 42 may be on the surface of the handle 12 and the stimulator 20 such that when the body 26 is rotated to be securely coupled to the handle 12, the electrical lead 44 on the stimulator 20 contacts the electrical lead 42 on the handle. In a particular embodiment the at least one electrical lead is a bump or a divot and a bump lead on the handle 42 can contact a divot lead on the stimulator 44 to provide electrical connection and relational stability when the stimulator 20 is coupled to the handle 12.

A penetrating body 22 may be coupled to or integral with the handle 12 and the oblong body 15 spaced apart from the penetrating body 22 to locate the stimulator 20 near the penis or clitoris of the user when the penetrating body 22 is completely inserted into the user. In a particular embodiment, the penetrating body is meant to be repetitively thrust and withdrawn from the user during use and the stimulation area 19 may be coupled to the handle 12 such that a sensation drive 24 contacts the clitoris, penis, or perineum of the use and is spring biased toward the user to provide constant contact of the sensation drive 24 to the user during thrusting of the penetrating body 22.

For partnered use, the handle may have a user side configured to face the user during use, an opposing side opposite to the user side 110. The stimulation end 16 has at least two oblong cutouts 15 to couple two or more stimulators 20 to the handle 12. A plurality of different kinds of penetrating bodies 22 and/or sensation drives 24 are provided as stimulators 20, each having a body 26 and an extension 30 from the body 26 by a stem 32. The length of the stem 32 may generally correspond to the depth of the oblong cutout 15 such that the stimulator 20 may be coupled to the handle 12 from the user side 110 of the handle and from the opposing side 120

Users may be allowed to select among a variety of stimulators to select a first stimulator 100 and a second stimulator 102. The first stimulator 100 may be coupled to the user side 110 of the handle 12 and the second stimulator 102 coupled to the opposing side 120 of the handle 12. End users could then use the sex aid with a partner, using the handle 12 to maneuver the stimulators 100, 102 to appropriate positions on each partner.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, the disclosed subject matter is in no way limited to a particular methodology, protocol, and/or reagent, etc., described herein. As such, various modifications, or changes to or alternative configurations of the disclosed subject matter can be made in accordance with the teachings herein without departing from the spirit of the present specification. Lastly, the terminology used herein is for the purpose of describing particular embodiments only and is not intended to limit the scope of the present disclosure, which is defined solely by the claims. Accordingly, embodiments of the present disclosure are not limited to those precisely as shown and described.

Certain embodiments are described herein, including the best mode known to the inventors for carrying out the methods and devices described herein. Of course, variations on these described embodiments will become apparent to those of ordinary skill in the art upon reading the foregoing description. Accordingly, this disclosure includes all modifications and equivalents of the subject matter recited in the claims appended hereto as permitted by applicable law. The terms “including” and “such as” are not limiting and should be interpreted as “including, but not limited to,” and “such as, for example,” respectively. Moreover, any combination of the above-described embodiments in all possible variations thereof is encompassed by the disclosure unless otherwise indicated herein or otherwise clearly contradicted by context.

I claim:

1. A sex toy accessory system for facilitating sexual arousal of at least one user, the sex toy accessory system comprising:
a handle having a user side configured to face the user during use, an opposing side opposite to the user side, a grip end, a stimulation end, and a length;
at least one oblong cutout near the stimulation end of the handle to couple at least one stimulator to the handle, wherein the oblong cutout has a depth;
wherein the at least one stimulator has a body and an extension wherein the extension comprises a stem and a face;
wherein the stem extends between the body and the face and has a length corresponding to the depth of the oblong cutout;
wherein the face is shaped to fit through the oblong cutout and rotate to secure the stimulator to the handle.

2. The sex toy accessory system of claim 1, wherein the at least one stimulator is at least one of a penetrating body and a sensation drive.

3. The sex toy accessory system of claim 2, wherein the sensation drive comprises at least one of a vibrator, an air pulse, a tongue flicker, a clamp, suction, and electrical stimulation.

4. The sex toy accessory system of claim 1 wherein the at least one user is a first user and a second user, wherein the at least one oblong cutout is a first oblong cutout and a second oblong cutout, and wherein at least one stimulator is a first stimulator and a second stimulator, the first oblong cutout is configured to accommodate the first stimulator such that the first stimulator may be used by the first user on the user side of the handle, and the second oblong cutout is configured to accommodate the second stimulator such that the second stimulator may be used by the second user on the opposing side of the handle.

5. The sex toy accessory system of claim 1, further comprising at least one handle electrical lead situated near the at least one oblong cutout and at least one stimulator electrical lead situated on the body of the at least one stimulator to provide an electrical connection between the handle and at least one stimulator.

6. The sex toy accessory system of claim 5 wherein battery energy stored in the handle is transmitted to the at least one stimulator to power the at least one stimulator.

7. The sex toy accessory system of claim 5 further comprising a control interface near the grip end of the handle wherein instructions from the control interface are relayed to the at least one stimulator.

8. The sex toy accessory system of claim 1 wherein each at least one stimulator has its own independent control interface.

9. The sex toy accessory system of claim 1 further comprising a stop on the handle that limits the rotation of the stimulator relative to the handle.

10. The sex toy accessory system of claim 1 further comprising a barbed toy attachment.

11. The sex toy accessory system of claim 1 further comprising a battery housed within the body of the stimulator.

12. The sex toy accessory system of claim 11, wherein the battery is coupled to at least one electrical lead that magnetically connects to a charger.

13. The sex toy accessory system of claim 1 wherein the at least one oblong cutout is a first oblong cutout and a second oblong cutout, wherein at least one stimulator is a first stimulator and a second stimulator, wherein the first stimulator is a penetrating body, and the second stimulator is a sensation drive, and wherein the distance between the first stimulator and the second stimulator is adjustable.

14. The sex toy accessory system of claim 1 wherein the handle is curved with no marked angle changes.

15. The sex toy accessory system of claim 1 further comprising an attachment face at the stimulation end of the handle, wherein the at least one oblong cutout is situated on the attachment face, and wherein the oblong cutout depth is equal to an attachment face depth.

16. A method of providing a variable action sex action, the method comprising the acts of:
providing a handle having a user side configured to face the user during use, an opposing side opposite to the user side, a grip end, a stimulation end, a length, and at least one oblong cutout near the stimulation end of the handle, the oblong cutout having a depth;
configuring at least one stimulator to have a body and an extension wherein the extension comprises a stem and a face, the stem extending a length between the body and the face;
configuring the length to generally correspond to the depth of the cutout, wherein the face is shaped to fit through the oblong cutout and rotate to secure the stimulator to the handle; and
providing the handle and stimulator to a user for assembly and use.

17. The method of claim 16 further comprising situating a battery in the body of the stimulator.

18. The method of claim 16, wherein the handle comprises a power source and at least one electrical handle lead in electrical communication with the power source, wherein the body has at least one electrical body lead such that when the body is rotated to be securely coupled to the handle, the at least one body lead is in electrical communication with the at least one handle lead.

19. The method of claim 16, further comprising coupling a penetrating body to the handle and spacing the oblong body such that the stimulator is near the penis or clitoris of the user when the penetrating body is completely inserted into the user.

20. The method of claim 16, further comprising coupling a penetrating body to the handle and spacing the oblong body such that the stimulator is near the penis or clitoris of the user when the penetrating body is partially inserted into the user, and configuring the handle to exert a spring bias to maintain contact between the user and the stimulator while the penetrating body is thrust into and removed from the user to varying degrees.

21. A method of enhancing a partnered sexual experience, the method comprising the acts of:
providing a handle having a user side configured to face the user during use, an opposing side opposite to the user side, a grip end, a stimulation end, and at least one oblong cutout near the stimulation end of the handle, the oblong cutout having a depth;
configuring a plurality of stimulators to have a body and an extension wherein the extension comprises a stem and a face, the stem extending a stem length between the body and the face that generally corresponds to the depth of the oblong cutout such that the stimulator may be coupled to the handle from the user side or from the opposing side;
allowing a user to select a first stimulator and a second stimulator from among the plurality of stimulators and couple the first stimulator to the user side of the handle and the second stimulator to the opposing side of the handle.

22. The method of claim 21 further comprising marketing the handle and stimulators to couples.
